(19) United States
(12) Patent Application Publication
(10) Pub. No.: US 2026/0228389 A1
(43) Pub. Date: Aug. 6, 2026

(54) GENERATING LOAD-BALANCED MULTI-CLUSTER NETWORK ON CHIP

(71) Applicant: Baya Systems, Inc., Santa Clara, CA (US)

(72) Inventors: Eric NORIGE, Santa Clara, CA (US); Honnahuggi Harinath Venkata Naga Ambica PRASAD, Bengaluru (IN)

(21) Appl. No.: 19/044,434

(22) Filed: Feb. 3, 2025

(51) Int. Cl. G06F 30/27; G06F 15/78; G06F 30/398; G06F 113/18; G06F 119/02

(52) U.S. Cl. CPC G06F 30/27; G06F 15/7825; G06F 30/398; G06F 2113/18; G06F 2119/02

(57) ABSTRACT

Aspects of the present disclosure are directed to a method and a system for generating a load-balanced multi-cluster Network on Chip (NoC) from a specification having multi-cluster topology and flows. The method includes generating a cross-cluster traffic specification from the specification, and initializing fractional flow distribution across boundary ports for flows of the cross-cluster traffic specification. The method further includes executing a process (e.g., by simulated annealing) to optimize the initialized fractional flow distributions against a cost function. The method includes allocating (e.g., by a bin-packing process) the flows of the specification between clusters of the NoC based on the optimized fractional flow distribution. The optimization process and the allocation of the optimized fractional flow distribution enables flows/traffic to be mapped to boundaries of the cluster in a load-balanced manner. Further, the method may also include pruning edges from the cross-cluster traffic specification/graph to eliminate formation of deadlocks and/or cycles.

### BACKGROUND

### Technical Field

Methods and example embodiments described herein are generally directed to construction of a Network on Chip (NoC), and more specifically, to generation of a load-balanced multi-cluster network on chip from a specification having multi-cluster topology and flows.

### Related Art

The number of components on a chip is rapidly growing due to increasing levels of integration, system complexity, and shrinking transistor geometry. Complex System-on-Chips (SoCs) may involve a variety of components, e.g., processor cores, Digital Signal Processors (DSPs), hardware accelerators, memory, and Input/Output (I/O) interfaces, while Chip Multi-Processors (CMPs) may involve a large number of homogenous processor cores, memory, and I/O subsystems. In both systems, the on-chip interconnect plays a key role in providing high-performance communication between the various components. Due to scalability limitations of traditional buses and crossbar-based interconnects, Network-on-Chip (NoC) has emerged as a paradigm to interconnect a large number of components on the chip.

The NoC is a global shared communication infrastructure made up of several routing nodes interconnected with each other using point-to-point physical links. Messages are injected by source components and are routed from the source router/nodes to a destination router/node over multiple intermediate nodes and physical links. The destination router/node then ejects the message to the destination component. For the remainder of the present disclosure, the terms ‘processing elements,’ ‘components,’ ‘endpoints,’ ‘blocks,’ ‘hosts,’ ‘agents,’ or ‘cores,’ will be used interchangeably to refer to the various system components that are interconnected using a NoC. The terms ‘routers’ and ‘nodes’ will also be used interchangeably. Without loss of generalization, a system with multiple interconnected components will itself be referred to as a ‘multi-core system’.

There are several possible topologies in which the routers can connect to one another to create the system network. Bi-directional rings 100A (as shown in FIG. 1A) and 2-D mesh 100B (as shown in FIG. 1B) are examples of topologies in the related art.

Packets are message transport units for intercommunication between various components. Routing involves identifying a path, which is a set of routers and physical links of the network over which packets are sent from a source component to a destination component. Components are connected to one or multiple ports of one or multiple routers; with each such port having a unique identifier (ID). Packets carry the destination's router and port ID for use by the intermediate routers to route the packet to the destination component.

Examples of routing techniques include deterministic/static routing, which involves choosing the same path from component A to component B for every packet. This form of routing is oblivious to the state of the network and does not load balance across path diversities which may exist in the underlying network. However, such deterministic routing may be simple to implement in hardware, maintains packet ordering, and may be easy to make free of network-level deadlocks. Shortest path routing minimizes the latency as it reduces the number of hops from the source component to the destination component. For this reason, the shortest path is also the lowest power path for communication between the two components. Dimension-order routing is a form of deterministic shortest-path routing in 2D mesh networks.

FIG. 2 illustrates an example of XY routing in a two-dimensional mesh 200. More specifically, FIG. 2 illustrates XY routing from node ‘34’ to node ‘00’. In the example of FIG. 2, each component is connected to only one port of one router. A packet is first routed in the X dimension until the packet reaches node ‘04’ where the X dimension is the same as that of the destination. The packet is next routed in the Y dimension until the packet reaches the destination node.

Source routing and routing using tables are other routing options used in NoC. Adaptive routing can dynamically change the path taken between two points on the network based on the state of the network. This form of routing may be complex to analyze and implement and is therefore rarely used in practice.

The NoC may contain multiple physical networks. Over each physical network, there may exist multiple virtual networks, where different message types are transmitted over different virtual networks. In this case, at each physical link or channel, there are multiple virtual channels (VCs), each of which may have dedicated buffers at both endpoints. In any given clock cycle, only one VC can transmit data on the physical channel.

NoC interconnects often employ wormhole routing, where a large message or packet is broken into small pieces known as flits (also referred to as flow control units). The first flit is the header flit which holds information about the packet's route and key message level information along with payload data and sets up the routing behavior for all subsequent flits associated with the message. Zero or more body flits follow the head flit, containing the remaining payload of data. The final flit is a tail flit, which in addition to containing the last payload, also performs some bookkeeping to close the connection for the message. In wormhole flow control, VCs are often implemented.

The physical channels are time-sliced into a number of independent logical channels, i.e. VCs. VCs provide multiple independent paths to route packets; however, they are time-multiplexed on the physical channels. A VC holds the state needed to coordinate the handling of the flits of a packet over a channel. At a minimum, this state identifies the output channel of the current node for the next hop of the route and the state of the virtual channel (idle, waiting for resources, or active). The VC may also include pointers to the flits of the packet that are buffered on the current node and the number of flit buffers available on the next node.

The term “wormhole” refers to the way messages are transmitted over the channels. The output port at the next router can be so short that received data can be translated in the head flit before the full message arrives. This allows the router to quickly set up the route upon arrival of the head flit and then opt-out from the rest of the conversation. Since a message is transmitted flit by flit, the message may occupy several flit buffers along its path at different routers, creating a worm-like image.

Based on the traffic between various endpoints, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies. However, all channels are equal in width or number of physical wires. This width can be determined based on the most loaded channel and the clock frequency of various channels.

### SUMMARY

Aspects of the present disclosure are directed to a method for generating a load-balanced multi-cluster Network on Chip (NoC) from a specification having multi-cluster topology and flows. The method includes generating a cross-cluster traffic specification from the specification, initializing fractional flow distribution across boundary ports for flows of the cross-cluster traffic specification, executing a process to optimize the initialized fractional flow distributions against a cost function, and allocating the flows of the specification between clusters of the NoC based on the optimized fractional flow distribution.

Other aspects of the present disclosure are directed to a system for generating a load-balanced multi-cluster NoC from a specification having multi-cluster topology and flows. The system includes a control module configured to generate a cross-cluster traffic specification from a specification having multi-cluster topology and flows, initialize fractional flow distribution across boundary ports for flows of the cross-cluster traffic specification, execute a process to optimize the initialized fractional flow distributions against a cost function, and allocate the flows of the specification between clusters of the NoC based on the optimized fractional flow distribution.

Further aspects of the present disclosure are directed to a computer readable medium storing instructions for generating a load-balanced multi-cluster NoC from a specification having multi-cluster topology and flows. The instructions include generating a cross-cluster traffic specification from the specification, initializing fractional flow distribution across boundary ports for flows of the cross-cluster traffic specification, executing a process to optimize the initialized fractional flow distributions against a cost function, and allocating the flows of the specification between clusters of the NoC based on the optimized fractional flow distribution.

### BRIEF DESCRIPTION OF THE DRAWINGS

FIGS. 1A and 1B illustrate examples of a bidirectional ring and two-dimensional (2D) Mesh Network on Chip (NoC) topologies.

FIG. 2 illustrates an example of XY routing in a NoC having a two-dimensional mesh topology.

FIG. 3 illustrates a schematic representation of a multi-cluster NoC topology with interconnecting global links, in accordance with an example implementation.

FIG. 4 illustrates a flowchart of an example method for generating a load-balanced multi-cluster NoC from a specification having multi-cluster topology and flow, in accordance with an example implementation.

FIG. 5 illustrates an example representation of a fractional flow distribution of a cross-cluster specification generated from the NoC specification, in accordance with an example implementation.

FIG. 6 illustrates an example computer/server block diagram upon which the example implementations described herein may be implemented.

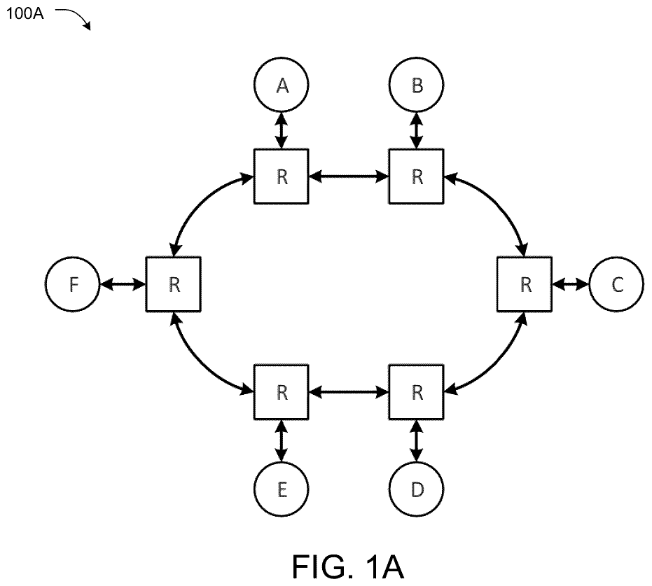

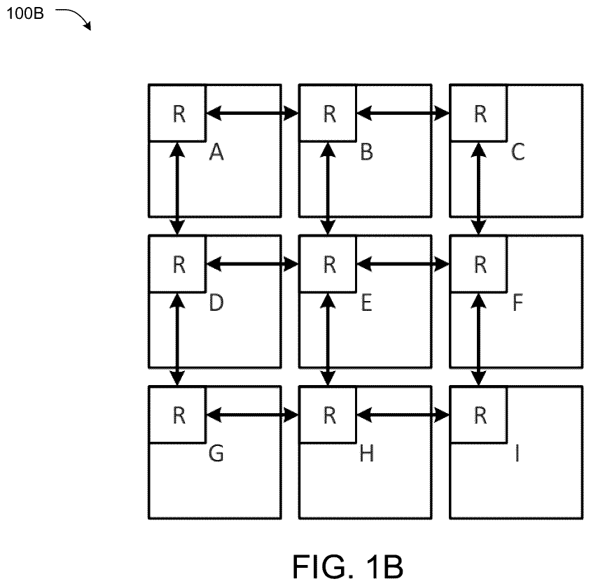

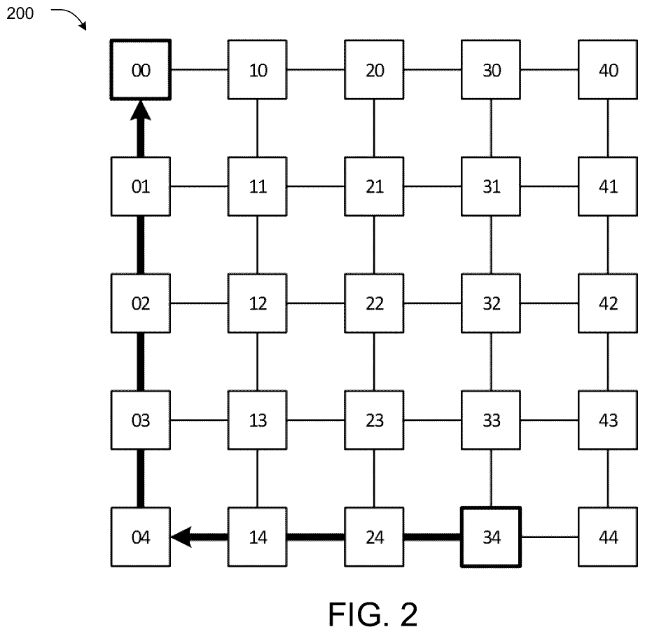

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic implementations (within a computing device or a computer system) or semi-automatic implementations involving user or administrator control over certain aspects of the implementation (through inputs provided using a user interface or the computing devices/system), depending on the desired implementation of one of ordinary skill in the art practicing implementations of the present application.

Network-on-chip (NoC) interconnects can be implemented as a network of one or more clusters, chiplets, or dies. In such implementations, each cluster includes one or more boundary ports that are internally connected to each other (i.e., through ‘local links’) to enable incoming traffic to be routed from one region/side (such as north, south, east, or west side) to another region/side of the cluster, and/or direct traffic to and from cores or processing elements associated with the clusters. Further, each of the clusters may also be interconnected with each other (i.e., by ‘global links’) through the boundary ports, to enable cluster-to-cluster communication. Since global links are typically more expensive than local links, there is a need to maximize the utilization of the global links. Accordingly, traffic/flows/load between any two cores or processing elements (such as a source and a destination) associated with two different clusters needs to be balanced across the global links, by automatically mapping traffic in a manner that prevents asymmetric loading (i.e., one available global link being congested or loaded with excessive traffic while another available global link is idle), deadlocks, cycles, and the like. Existing solutions fail to provide means or techniques to enable such assignment/allocation.

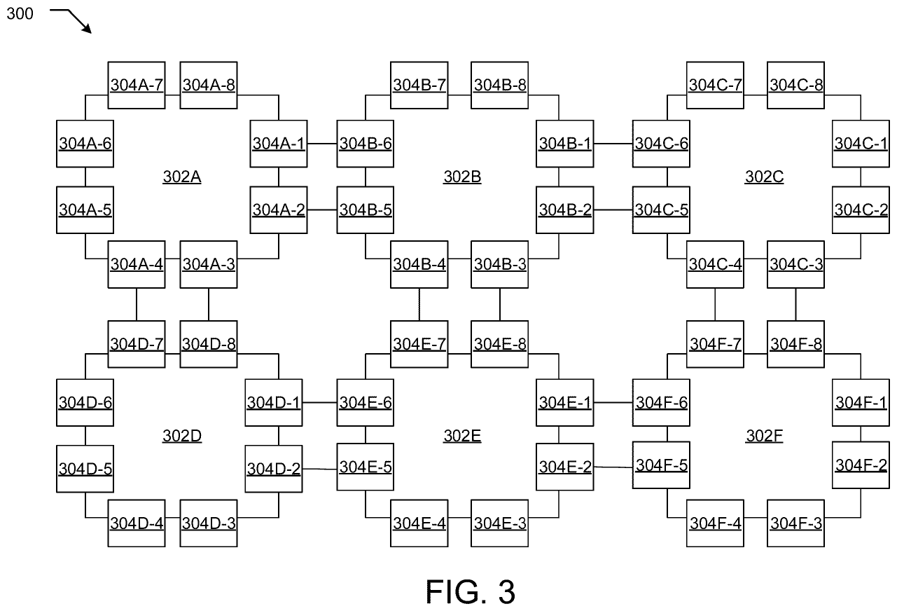

The present disclosure provides a system, a method, and a non-transitory computer readable medium, that automatically generates load-balanced multi-cluster networks based on a specification having a multi-cluster topology and flows. In an aspect, the method includes generating a cross-cluster traffic specification from the specification (e.g., in the form of graphs where nodes correspond to boundary ports of clusters defined in the specification, and edges correspond to (global) links between boundary ports of different clusters). The method then includes initializing fractional flow distribution across boundary ports for flows of the cross-cluster traffic specification. Further, the method includes executing a process (such as simulated annealing or a machine learning process) to optimize the initialized fractional flow distributions against a cost function (based on variance of loads on the links connecting the boundary ports), and allocating the flows of the specification between clusters of the NoC based on the optimized fractional flow distribution (through a bin-packing process). The optimized fractional flow distribution may be indicative of a maximum/total flow rate that may be pushed through the global links associated with the boundary ports of each cluster. The fractional flow distribution may be optimized to balance load/traffic/flows across the global links, and also maximally utilize the bandwidth thereof. Further, the method may also include pruning edges from the cross-cluster traffic specification/graph to eliminate formation of deadlocks and/or cycles. Various embodiments of the present disclosure are described in detail in reference to FIGS. 3 to 6.

Referring to FIG. 3, an example NoC 300 may include a network of clusters 302A to 302F (collectively referred to as clusters). Each of the clusters 302 may include one or more boundary ports (such as boundary ports 304A-1 to 304A-8 in cluster 302A, boundary ports 304B-1 to 304B-8 in cluster 302B, and so on, which are collectively referred to as boundary ports 304). While FIG. 3 shows embodiments where each of the clusters 302 has the same number of boundary ports 304, in other embodiments, each of the clusters 302 may have a different number of boundary ports 304. For example, each of the clusters 302 may be instances of different sub-NoC designs. The boundary ports 304 of each cluster 302 may be connected through local links, which are hidden from FIG. 3 for the purposes of clarity.

Further, each of the clusters 302 may be interconnected through global links that enable traffic to flow from one cluster to another. The global links between each of the clusters 302 are shown using solid lines between boundary ports 304 of each cluster 302. In some embodiments, each of the boundary ports 304 may be connected through parallel global links. For example, boundary port 304A-1 may be connected to boundary port 304B-6 through a first global link and boundary port 304A-2 may be connected to boundary port 304B-5 through a second global link. Alternatively, or additionally, the boundary ports 304 may also be connected through diagonal links or cross links. For example, boundary port 304A-1 may be connected to boundary port 304B-5 through a third global link and boundary port 304A-2 may be connected to boundary port 304B-6 through a fourth global link.

In some embodiments, the NoC 300 may have a grid topology, as shown in FIG. 3. In other embodiments, the NoC 300 may have any other regular or irregular topology, and/or any other two-dimensional or three-dimensional topology as defined in a specification provided by a user (such as a NoC designer or manufacturer). In some embodiments, the specification may also include flows indicative of packets that may be transmitted between different cores/processing elements/agents associated with the clusters 302.

In some embodiments, each flow may specify packets to be transmitted from a source processing element/core/agent in a source cluster (such as source cluster 302A) to a destination processing element/core/agent in a destination cluster (such as destination cluster 302F). In such embodiments, the packets may be transmitted through a path including a combination of local links connecting the boundary ports 304 within each cluster 302, and the global links between the clusters 302. In some embodiments, the packets may be directly sent from the source cluster to the destination cluster, when both are adjacent or neighboring each other. In other embodiments, the packets from the source may be transmitted to the destination in the destination cluster 302F through intermediate clusters or pass-through clusters 302B and 302C. For example, packets from the source in the source cluster 302A may be transmitted to the destination in the destination cluster 302F through intermediate clusters or pass-through clusters 302B and 302C. In such examples, the source may transmit the packets to the source cluster 302A through a bridge therein. Further, the bridge may direct the packet to one of the boundary ports 304A of the source cluster 302A through local links therebetween. Thereafter, the packets may be ejected from the source cluster 302A to pass-through cluster 302B, such as through boundary port 304A-1. Since the pass-through cluster 302B does not include the destination, the packet may be directed to one of the boundary ports 304B of the pass-through cluster 302B closest to the destination cluster 302F. For instance, the packets may be received at one boundary port (such as boundary port 304B-6), and ejected out of the cluster 302 through another boundary port (such as boundary port 304B-1). Once the packet reaches the destination cluster 302F, the boundary port thereof (such as boundary port 304F-8) may direct the packet to the destination through a corresponding bridge in the destination cluster 302F. Other paths may also be available for transmitting packets associated with a flow defined in the specification, based on the topology of the NoC 300.

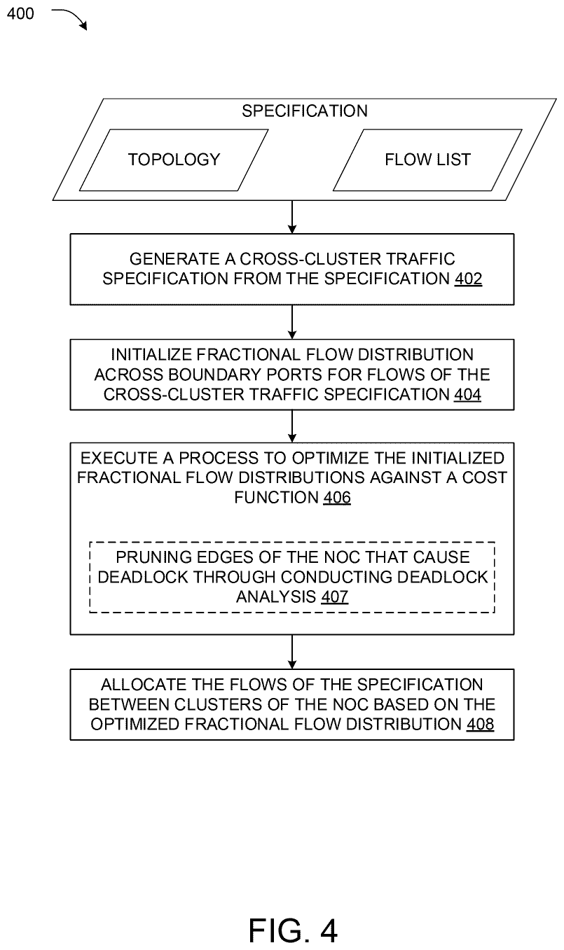

As stated, flows need to be assigned/mapped/allocated to a global path. The global path may be a combination of global links and local links used for transmitting the packets from the source to the destination. The flows may be assigned in a manner that maximally utilizes the global links, balances load between the global links, prevents deadlocks and cycles, and the like, among other constraints of the use case. In some embodiments, method 400 shown in FIG. 4 may be used for generating NoCs that are load-balanced, and satisfy other constraints listed in the specification.

Referring to FIG. 4, a flowchart of the method 400 for generating a load-balanced multi-cluster NoC from a specification having multi-cluster topology and flows is shown. The method 400 may be implemented automatically by a computing device/system, or semi-automatically with the aid of a user.

At step 402, the method 400 includes generating a cross-cluster traffic specification from the specification. As stated, the specification defined and provided by the user may include the topology of the NoC (such as NoC 300), and the flows between the clusters (such as clusters 302) of the NoC 300. In some embodiments, the cross-cluster traffic specification may be generated by consolidating all flows associated with any two clusters 302, i.e., all traffic/flows emanating from boundary ports of a first cluster to boundary ports of a second cluster. For example, the cross-cluster traffic specification may include a consolidated/aggregated value or a set of flows between each pair of neighboring clusters (such as clusters 302A and 302B, clusters 302A and 302D, and so on). For each pair of neighboring clusters Cᵢ and Cⱼ (where ‘i’ corresponds to an identifier for transmitting/source/origination cluster and ‘j’ corresponds to an identifier for receiving/destination/termination cluster), the cross-cluster traffic specification may include a consolidated traffic set Tᵢⱼ. For example, the flows/traffic between the neighboring clusters Cᵢ and Cⱼ may include set Tᵢⱼ={tᵢⱼ₀, tᵢⱼ₁, tᵢⱼ₂, tᵢⱼ₃, . . . , tᵢⱼₙ₋₁}, where each tᵢⱼₖ relates to the k^{th} flow from cluster Cᵢ to cluster Cⱼ. The set Tᵢⱼ may include the flows from source processing elements/cores associated with cluster Cᵢ to destination processing elements/cores associated with cluster Cⱼ, and the flows from sources in cluster Cₓ to destinations in cluster Cy or cluster Cⱼ that use the cluster Cᵢ as a pass-through cluster (which may be represented as t_{xyn}), via the global links between Cᵢ and Cⱼ.

At step 404, the method 400 includes initializing fractional flow distribution across boundary ports 304 for flows of the cross-cluster traffic specification. In some embodiments, the fractional flow distribution may include a flow rate assigned to each boundary ports 304 of different clusters 302. The flow rate may indicate possible utilization of the global links (with respect to capacity/bandwidth thereof, for example). In some examples, the global links may be optimally utilized, over utilized, or under-utilized. In some embodiments, the flow rate may be a fraction (i.e., a number between 0 and 1) of the total cross-cluster traffic defined in the cross-cluster traffic specification that the global links between two clusters 302 of the NoC 300 may support (i.e., the percentage of flows/traffic that may be transmitted through the global link from the corresponding boundary port 304). In some embodiments, the flow rates/fractional flow distribution may be initialized randomly. In an example, one of the boundary ports 304 between neighboring clusters 302 may be initialized a flow rate of 0.8, and the other global links of the neighboring clusters 302 may be initialized to a flow rate of 0.2. In further embodiments, the initialized fractional flow distribution may be determined and received from the user through a user interface.

Since the flow rates are fractions of the cross-cluster traffic, the flow rates may be assigned such that the sum of all αᵢⱼₖ is equal to 1, where ‘k’ corresponds to an identifier for the boundary ports 304 of the cluster Cᵢ from which the traffic may flow to the cluster Cⱼ. In some embodiments, each of the global links may be associated with two flow rates, each corresponding to each direction in which the traffic may flow through the global links. For example, the global link between the boundary port 304A-1 of the first cluster 302A and the boundary port 304B-6 of the second cluster 302B may be associated with a first flow rate α_{AB1} (as assigned to boundary port 304A-1) for flows from the boundary port 304A-1 to boundary port 304B-6 (as provided in traffic TAB), and a second flow rate α_{BA1} (as assigned to boundary port 304B-6) for flows from the boundary port 304B-6 to boundary port 304A-1 (as provided in traffic T_{BA}).

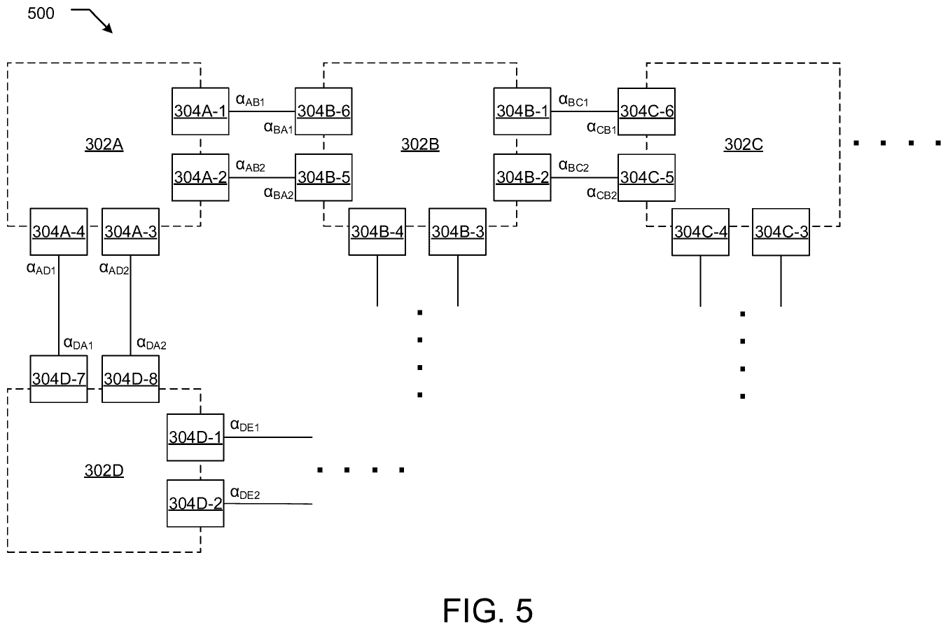

In some embodiments, the NoC 300 may be represented using a graph data structure, where nodes of the graph correspond to the boundary ports 304 of each cluster 302, and the edges correspond to the global links between the boundary ports 304 of different clusters 302, as shown in the partial representation 500 of the NoC 300 in FIG. 5. Further, weights of the edges (based on direction) may correspond to the flow rates (such as flow rates α_{AB1} and α_{AB2} between boundary ports 304A-1 and 304A-2 of clusters 302A and 302B, flow rates α_{AD1} and α_{AD2} between boundary ports 304A-3 and 304A-4 of clusters 302A and 302D, and so on) defined in the fractional flow distribution across the boundary ports 304. The representation of the topology of the clusters 302 of the NoC 300 and the flows between the clusters 302 through a graph may enable a computing device to parse and process the specification, and identify a load balanced manner of transmitting packets through the NoC 300.

At step 406, the method 400 includes executing a process to optimize the initialized fractional flow distributions against a cost function. The flow rates αᵢⱼₖ for each boundary port 304 for each cross-cluster traffic as defined by the initialized fractional flow distribution of each cluster 302 may be determined/optimized such that a cost derived by the cost function is minimized. In some embodiments, the cost function may be based on variance of loads on (the global) links connecting the boundaries/boundary ports 304 of the clusters 302 of the NoC 200. In some embodiments, a variance (represented as Vij) may be determined for each set of global links between two clusters 302 (such as for each neighboring cluster Cⱼ of cluster Cᵢ), or side/region/direction (i.e., north, south, east, or west sides/regions/directions). The variance may be aggregated/summed to obtain a cross-cluster variance cost (represented as ΣVCᵢ for each cluster Cᵢ). By minimizing the cost function (such as the variance) on each side/region/direction of the clusters 302, the flow rates αᵢⱼₖ may be optimized such that flows/traffic emanating from each side/region/direction of the clusters 302 are balanced across the boundary ports 304/global links on that side/region/direction. Hence, in some embodiments, the magnitude of load handled by different sets of boundary ports 304 (corresponding to each side/region/direction) of the cluster 302 may be different, while each set of boundary ports 304 may have minimal variance.

In some embodiments, the (optimization) process may be one or more of, a simulated annealing process, a machine learning process, a genetic algorithm, a local search, cross-entropy methods, and the like, but not limited thereto. For example, when the optimization process is the simulated annealing process, the initialized fractional flow distribution may be adjusted by reducing or increasing flow rates of the global links having high utilization or low utilization (where whether the utilization is high or low is determined based on a comparison of a ratio between the initialized/assigned flow rate and capacity of the global links), respectively, over multiple iterations. At each iteration, the ratio of the flow rates assigned to the global links (or corresponding boundary ports 304) from which the traffic/flow exits the cluster 302 may be adjusted by increasing and/or decreasing at least one of the flow rates in the fractional flow distribution. In some embodiments, if the cost obtained using the cost function reduces, the adjustment to the fractional flow distribution is accepted, and used as (initial) flow rates for the next iteration. In other embodiments, if the cost increases or remains constant, the adjustment is accepted with a certain probability based on a temperature. Accepting adjustments that increase the cost may allow the optimization process to climb out of local optima, and move towards a global optimum. The temperature decreases at each iteration according to a cooling schedule. In some embodiments, the optimization process may be iterated until a stopping condition is met, such as convergence to a global optimum, the number of iterations being greater than a predetermined number, the change in the cost being less than a predetermined threshold for a predetermined number of preceding iterations, and so on.

In other examples, a machine learning process may be executed by a machine learning model to determine the optimal flow rates. The machine learning model may be any one or a combination of regression models, decision trees, neural networks, and the like. The machine learning model may be trained by gradient descent using the cost function, such as the sum of variances. In some embodiments, the machine learning process may be trained to use the specification having the topology and the flows as input, and generate the optimized fractional flow distribution as output. In other embodiments, the machine learning process may use the cross-cluster traffic specification, and the initialized fractional flow distribution as input and generate the optimized fractional flow distribution as output. In further embodiments, any other optimization algorithm may be suitably adapted for generating the optimized fractional flow distribution.

During the optimization process, some adjustments may lead to configurations of the global links that cause deadlocks. In such embodiments, the optimization process may include identifying the formation of deadlocks by conducting a deadlock analysis. In some embodiments, at step 407, the method 400 may include pruning edges of the NoC 300 that cause deadlock through conducting the deadlock analysis. In some embodiments, the deadlock analysis may be performed by constructing a dependency graph or a waits-for graph for paths of the flows provided in the specification. The presence of cycles in the constructed wait-for graphs may be used to identify deadlocks. A subset of edges (or the last edge that completes the cycle) in the waits-for graph having deadlocks may be excluded from a solution space explored by the simulated annealing/optimization process. In such embodiments, the edges (i.e., the flow rates αᵢⱼₖ) may be assigned a value of 0 or infinite. Since such adjustments have an infinite cost, such adjustments may be rejected and not used for the subsequent iterations. The exclusion/pruning of the edges may prevent the flow rates of such global links (or originating boundary ports 304 thereof) from being adjusted during the optimization process. The deadlock analysis may be performed before each iteration (including after the generation of the initialized fractional flow distribution), where different lists of edges may be excluded for the solution space exploration of the optimization process.

The optimization process may yield the optimized fractional flow distribution, which may include optimized flow rates (i.e., the adjusted flow rates αᵢⱼₖ) for each global link associated with the boundary ports 304 of each cluster 302 of the NoC 300. The optimized fractional flow distribution may indicate a load-balanced manner in which the flows/traffic may be allocated/mapped to different paths or global links through which the flows may be transported. Further, the optimization process may be adapted such that the sum of the optimal flow rates is less than the capacity/bandwidth of the global links.

Other constraints may also be imposed on the optimization process (aside from the cost function). In some embodiments, the optimization of the initialized fractional flow distributions may be based on an arbitration radix of the NoC 300. In such embodiments, the optimization process may account for the arbitration radix of the NoC 300, which may provide a trade-off between loads/congestion on each link and the cost of the links of the NoC 300. For example, a higher arbitration radix may provide a higher number of global links between the clusters 302 which increases cost, but enables better load balancing and lowers congestion. Further, a lower arbitration radix may decrease cost, but congest the global links between the clusters 302. Further, in some embodiments, the optimization of the initialized fractional flow distributions may be further based on a throughput versus area tradeoff.

At step 408, the method 400 includes allocating the flows of the specification between the clusters 302 of the NoC 300 based on the optimized fractional flow distribution. In such embodiments, the flows provided in the specification (i.e., from the set Tᵢⱼ) between two clusters 302 (such as Cᵢ and Cⱼ) emanating from the corresponding boundary ports 304 (Bᵢₖ) may be allocated based on the optimized fractional flow distribution, i.e., according to the optimal flow rates determined by the optimization process. For example, a first subset of flows in set Tᵢⱼ (such as {tᵢⱼ₀, tᵢⱼ₁}) may be allocated to boundary port Bᵢ₁, and a second subset of flows in set Tᵢⱼ (such as {tᵢⱼ₂, tᵢⱼ₃}) may be allocated to boundary port Bᵢ₂. The flows may be allocated such that the bandwidth consumed by the flows is approximately equal to the optimal flow rate determined for the global links/boundary ports 304. In some embodiments, the flows may be allocated (and/or the optimal flow rates may be determined) such that the sum of the flows/traffic allocated is less than the capacity/bandwidth of the global link.

In some embodiments, allocating the flows of the specification between the clusters 302 may be conducted through a bin-packing process. The flows from the set Tᵢⱼ may be distributed to the originating boundary ports 304 between the clusters 302 according to the optimized flow rate determined for the boundary ports 304. In some embodiments, for the bin-packing process, the flows tᵢⱼₙ from the set Tᵢⱼ may be used as items and the boundary ports (and the corresponding optimal flow rates αᵢⱼₖ) may be used as bins for the bin packing process.

The sum of flows distributed to the different boundary ports 304 may be different from the optimal flow rates assigned thereto, i.e., the bins may be underfilled or overfilled. In some embodiments, the flows may be split for the allocation during the bin-packing process. In such embodiments, the flows between two clusters 302 may be assigned different paths through the NoC 300. The flows may be split and allocated to the boundary ports 304 to optimally utilize the bins. In some embodiments, additional constraints for the bin-packing process may include minimizing the number of splits or splitting flows across paths.

### Example Scenario

In an example, the multi-cluster NoC may include 3 clusters, viz., clusters 302A/C_{A}, 302B/C_{B}, and 302C/C_{C}. The three clusters may be arranged in a series/array, where clusters 302A and 302B have at least two global links (emanating and/or terminating at boundary ports 304A-1/B_{A1}, 304A-2/B_{A2}, 304B-5/B_{B3}, 304B-6/B_{B4}) therebetween and clusters 302B and 302C have at least two global links therebetween (emanating and/or terminating at boundary ports 304B-1/B_{B1}, 304B-2/B_{B2}, 304C-5/B_{C1}, 304C-6/B_{C2}). Each of the global links may have a capacity or bandwidth associated therewith. In the foregoing example, all global links are assumed to have the same capacity (such as 100 units of traffic). Further, the specification may include flows between each of the clusters 302, such as traffic/flow t_{AB1} indicative of 2 units of flow, t_{AB2} indicative of 5 units of flow, and so on, between clusters 302A/C_{A}, and 302B/C_{B}. The flows/traffic between each pair of clusters 302 may be consolidated into a cross-cluster traffic specification, which may be represented in Table 1 as:

TABLE 1

| | Clusters | Clusters | Clusters |
|---|---|---|---|
| Traffic | 302A/C_{A} | 302B/C_{B} | 302C/C_{C} |
| Clusters 302A/C_{A} | — | 10 | 20 |
| Clusters 302B/C_{B} | 20 | — | 0 |
| Clusters 302C/C_{C} | 10 | 0 | — |

In Table 1, the source/origination clusters are listed in each row on the left, and the destination/termination clusters are listed in each column on the top of the table. For instance, cluster 302A/C_{A} may have 10 units of traffic/flow to be transmitted to cluster 302B/C_{B}, and 20 units of traffic/flow to be transmitted to cluster 302C/C_{C}. Since there are no global links between clusters 302A/C_{A} and 302C/C_{C}, the traffic/flows may be transmitted using cluster 302B/C_{B} as a pass-through cluster.

The cross-cluster traffic may be consolidated by aggregating all flows/traffic that may be transmitted between two clusters 302, including flows/traffic that use some of the clusters 302 as pass-through clusters. For example, since cluster 302B/C_{B} is also used as a pass-through cluster, the total traffic represented by set TAB from cluster 302A/C_{A} to cluster 302B/C_{B} may be equal to 30 units of flow/traffic (i.e., 10 units between clusters 302A/C_{A} and 302B/C_{B} and 20 units between clusters 302A/C_{A} and 302C/C_{C}). Similarly, the cross-cluster traffic specification may include total traffic/flows between every pair of clusters 302.

Once the cross-cluster traffic specification has been generated, fractional flow distributions may be initialized. The initialized fractional flow distributions may include flow rates (i.e., αᵢⱼₖ) of each of the boundary ports 304/Bᵢₖ initialized to a value between 0 and 1. For instance, the boundary port 304A-1/B_{A1} may be assigned the flow rate α_{AB1} of 0.1 and the boundary port 304A-2/B_{A2} may be assigned a flow rate of 0.9, for all flows or traffic emanating from cluster 302A/C_{A} and terminating at cluster 302B/C_{B}. The initialized flow rates may be either generated randomly, or provided by the user through the user interface of the computing device/system.

The initialized fractional flow distribution may then be optimized through execution of a process (such as simulated annealing and/or machine learning), based on a cost function (such as the sum of variances in the cross-cluster traffic). The cost may be determined using the cost function at each iteration of the process. For instance, in at least one iteration of the process, the fractional flow distribution may hold the values represented in Tables 2, 3 and 4:

TABLE 2
Representing fractional flow distribution
of boundaries in cluster 302A/CA

| Flow rates α_{Ajk} | To Cluster 302B/C_{B} | To Cluster 302C/C_{C} |
|---|---|---|
| Boundary port B_{A1} | 1 (i.e., 100% of 10 | 0.25 (i.e., 25% of 20 |
| | units of traffic, | units of traffic, |
| | which is 10 units) | which is 5 units) |
| Boundary port B_{A2} | — | 0.75 (i.e., 15 units) |

TABLE 3
Representing fractional flow distribution
of boundaries in cluster 302B/CB

| Flow rates α_{Bjk} | To Cluster 302A/C_{A} | To Cluster 302C/C_{C} |
|---|---|---|
| Boundary port B_{B1} | — | 0.5 |
| Boundary port B_{B2} | — | 0.5 |
| Boundary port B_{B3} | 0.5 | — |
| Boundary port B_{B4} | 0.5 | — |

TABLE 4
Representing fractional flow distribution
of boundaries in cluster 302C/CC

| Flow rates α_{Cjk} | To Cluster 302B/C_{B} | To Cluster 302A/C_{A} |
|---|---|---|
| Boundary port B_{C1} | — | 0.4 (i.e., 4 units) |
| Boundary port B_{C2} | — | 0.6 (i.e., 6 units) |

As shown in Table 2, the total traffic emanating from each of the boundary ports 304A/B_{Ak} is equal to 15 units (i.e., 10 units+5 units for boundary port 304A-1/B_{A1}, and 15 units for boundary port 304A-2/B_{A2}). Since both the values are equal, the variance thereof may be 0, hence requiring no adjustment to the flow rates α_{Ajk} of the cluster 302A/C_{A}. Similarly, cluster 302B/C_{B} may be configured to evenly (at 50%) distribute the flows received from either of clusters 302A/C_{A} and 302C/C_{C} to the corresponding destination clusters 302. However, in the example shown, the boundary ports 304C/Bck of the cluster 302C/C_{C} emanate traffic unevenly (i.e., 4 units and 6 units). In such cases, the variance of the flow rates assigned to boundary ports 304C-5/B_{C1} and 304C-6/B_{C2} may be equal to 2. The variance of all boundary ports (including boundary ports 304C-3 and 304C-4) of the cluster 302C may also be determined and summed to obtain the cost, according to the cost function. During the optimization process, the flow rates α_{Cjk} may be adjusted to 0.5 and 0.5 for the boundary ports 304C-5/B_{C1} and 304C-6/B_{C2}, respectively, such that the variance thereof is reduced, thereby minimizing the cost function, and providing better balance of the load therebetween. The iteration may be terminated once the stopping criterion is met, indicating that the optimized fractional flow distribution is or is near the global optimum for load balancing.

The flows/traffic in the set Tᵢⱼ may then be allocated to the boundary ports 304 based on the optimized fractional flow distribution. The allocation may be performed using a bin-packing process. For example, set T_{CB} representing a set of flows from the cluster 302C/C_{C} to the cluster 302B/C_{B} may include the flows t_{CB0}=2 units, t_{CB1}=3 units, and t_{cB2}=5 units. The flows in the set T_{CB} may be used as items for the bin-packing process. Further, the optimized flow rates α_{Cjk} in the optimized fractional flow distribution may be used as bins for the bin packing process, which in the forgoing example are 0.5 and 0.5 (i.e., 5 units each) for the boundary ports 304C-5/B_{C1} and 304C-6/B_{C2}. The flows may be allocated to the boundary ports 304C such that the sum of the flows does not exceed the optimized flow rates α_{Cjk}. For instance, the flows t_{CB0} and t_{CB1} may be allocated to the boundary port 304C-5/B_{C1}, and flow t_{CB2} may be allocated to the boundary port 304C-6/B_{C2}.

In other examples, the set T_{CB} representing the set of flows from the cluster 302C/C_{C} to the cluster 302B/C_{B} may include the flows t_{CB0}=2 units, t_{CB1}=2 units, and t_{cB2}=6 units. In such examples, since every combination of the flows t_{CBn} leads to a situation where the bins are overutilized, the flows t_{CBn} may be split into multiple flows (such as the flow t_{CB2} being split into t_{{CB2}}¹=5 units and t_{{CB2}}¹=1 unit). The split flows may then be allocated to the boundary ports 304C such that the overutilization/overfilling of the bins is prevented. For instance, the flows t_{CB0}, t_{CB1} and t_{{CB2}}² may be allocated to the boundary port 304C-5/B_{C1}, and flow t_{{CB2}}¹ may be allocated to the boundary port 304C-6/B_{C2}. In other examples, the split flows may be routed through different paths, such as the flow t_{{CB2}}¹ being routed through boundary port 304C-5/B_{C1}, and the flow t_{{CB2}}² being routed through boundary port 304C-4, if such paths exist.

The method 400 enables generation of multi-cluster NoCs that are load balanced. The method 400 provides addressable static routes that may be utilized for transmitting packets from sources in one cluster and destinations in another cluster. The optimization of the fractional flow distribution and the allocation of the flows to the boundary ports 304 for ejection based on the optimization enables the traffic to be balanced, thereby maximally utilizing all resources available to the NoC. Further, the deadlock analysis during the optimization prevents formation of cycles or deadlocks, thereby enabling the optimization process to exclude invalid solutions.

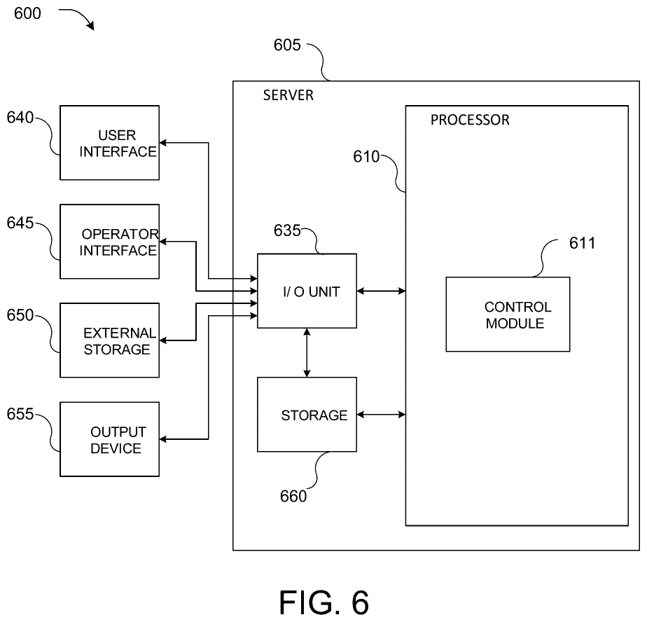

The method 400 of the present disclosure may be implemented in a computer/computing device or system. FIG. 6 illustrates an example computer system 600 on which example embodiments may be implemented. The computer system 600 includes a server 605 which may include an I/O unit 635, storage 660, and a processor 610 operable to execute one or more units as known to one of skill in the art. The term “computer-readable medium” as used herein refers to any medium that participates in providing instructions to processor 610 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include transitory media such as carrier waves. The Input/Output (I/O) unit 635 processes input from user interfaces 640 and operator interfaces 645 which may utilize input devices such as a keyboard, mouse, touch device, or verbal command.

The server 605 may also be connected to an external storage 650, which can contain removable storage such as a portable hard drive, optical media (CD or DVD), disk media, or any other medium from which a computer can read executable code. The server 605 may also be connected to an output device 655, such as a display to output data and other information to a user, as well as request additional information from a user. The connections from the server 605 to the user interface 640, the operator interface 645, the external storage 650, and the output device 655 may be via wireless protocols, such as the 802.11 standards, Bluetooth® or cellular protocols, or via physical transmission media, such as cables or fiber optics. The output device 655 may therefore further act as an input device for interacting with a user. The processor 610 may be configured to execute a control module 611. The control module 611 may be configured to implement the method 400 for generating a load-balanced multi-cluster NoC from a specification having multi-cluster topology and flows, among performing other functions.

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example embodiments, the steps carried out require physical manipulations of tangible quantities for achieving a tangible result.

Moreover, other implementations of the example embodiments will be apparent to those skilled in the art from consideration of the specification and practice of the example embodiments disclosed herein. Various aspects and/or components of the described example embodiments may be used singly or in any combination. It is intended that the specification and examples be considered as examples, with a true scope and spirit of the embodiments being indicated by the following claims.

What is claimed is:

1. A method for generating a load-balanced multi-cluster Network on Chip (NoC) from a specification having multi-cluster topology and flows, comprising:
generating a cross-cluster traffic specification from the specification;
initializing fractional flow distribution across boundary ports for flows of the cross-cluster traffic specification;
executing a process to optimize the initialized fractional flow distributions against a cost function; and
allocating the flows of the specification between clusters of the NoC based on the optimized fractional flow distribution.

2. The method of claim 1, wherein the process comprises one or more of simulated annealing or a machine learning process.

3. The method of claim 1, further comprising pruning edges of the NoC that cause deadlock through conducting deadlock analysis.

4. The method of claim 1, wherein the cost function is based on variance of loads on links connecting the boundaries of the clusters of the NoC.

5. The method of claim 1, wherein the allocating the flows of the specification between the clusters is conducted through a bin-packing process.

6. The method of claim 5, wherein the flows are split for the allocation during the bin-packing process.

7. The method of claim 1, wherein the optimizing the initialized fractional flow distributions is based on an arbitration radix of the NoC.

8. The method of claim 1, wherein the optimizing the initialized fractional flow distributions is based on a throughput versus area tradeoff.

9. A system comprising a control module, configured to:
generate a cross-cluster traffic specification from a specification having multi-cluster topology and flows;
initialize fractional flow distribution across boundary ports for flows of the cross-cluster traffic specification;
execute a process to optimize the initialized fractional flow distributions against a cost function; and
allocate the flows of the specification between clusters of the NoC based on the optimized fractional flow distribution.

10. The system of claim 9, wherein the process comprises one or more of simulated annealing or a machine learning process.

11. The system of claim 9, wherein the control module is further configured to prune edges of the NoC that cause deadlock through conducting deadlock analysis.

12. The system of claim 9, wherein the cost function is based on variance of loads on links connecting the boundaries of the clusters of the NoC.

13. The system of claim 9, wherein the allocation of the flows of the specification between the clusters is conducted through a bin-packing process.

14. The system of claim 13, wherein the flows are split for the allocation during the bin-packing process.

15. The system of claim 9, wherein the optimization of the initialized fractional flow distributions is based on an arbitration radix of the NoC.

16. The system of claim 9, wherein the optimization of the initialized fractional flow distributions is based on a throughput versus area tradeoff.

17. A non-transitory computer-readable medium storing instructions for generating a load-balanced multi-cluster Network on Chip (NoC) from a specification having multi-cluster topology and flows, the instructions comprising:
generating a cross-cluster traffic specification from the specification;
initializing fractional flow distribution across boundary ports for flows of the cross-cluster traffic specification;
executing a process to optimize the initialized fractional flow distributions against a cost function; and
allocating the flows of the specification between clusters of the NoC based on the optimized fractional flow distribution.

18. The non-transitory computer-readable medium of claim 17, wherein the instructions further comprise pruning edges of the NoC that cause deadlock through conducting deadlock analysis.

19. The non-transitory computer-readable medium of claim 17, wherein the cost function is based on variance of loads on links connecting the boundaries of the clusters of the NoC.

20. The non-transitory computer-readable medium of claim 17, wherein the allocating the flows of the specification between the clusters is conducted through a bin-packing process.
